(19) United States
(12) Patent Application Publication
(10) Pub. No.: US 2005/0059434 A1
(43) Pub. Date: Mar. 17, 2005

(54) Method for providing background sound effect for mobile phone

(76) Inventor: Chi-Jen Hong, Tu Cheng City (TW)

Correspondence Address: BIRCH STEWART KOLASCH & BIRCH, PO BOX 747, FALLS CHURCH, VA, 22040-0747, US

(21) Appl. No.: 10/660,576

(22) Filed: Sep. 12, 2003

(51) Int. Cl. H04M 1/00

(52) U.S. Cl. 455/567; 455/412.2

(57) ABSTRACT

A method provides a background sound effect for mobile phone communication through a carrier. An initial talking message such as a call-answering message by any of the two communication parties is firstly detected and a background sound effect is selected in an audio memory module in the mobile phone. The background sound effect is sent to the carrier by a DSP unit. Therefore, the two communication parties can simultaneously hear the background sound effect.

### FIELD OF THE INVENTION

The present invention relates to a method for providing background sound effects for mobile phone, and especially to a method for storing at least one background sound effect in mobile phone such that two conversation parties can simultaneously hear the background sound effect during conversation.

### BACKGROUND OF THE INVENTION

The rapid growth of mobile communication and mobile computing technology has had a huge impact on lifestyles and business modes of modern people. More particularly, the mobile phone has been developed to have many versatile functions and has become omnipresent.

Increasing numbers of user-friendly functions are continuously added to the original communication functions of the mobile phone. For example, the mobile phone is also equipped with a caller ID function, vibration for indicating an incoming call, and a message function. The mobile phone can also access wireless network through the wireless application protocol (WAP). To provide a more attractive effect, choral tones are also added to the ring tone of the mobile phone.

### SUMMARY OF THE INVENTION

It is an object of the present invention to provide a method for providing a background sound effect for a mobile phone communicating through a carrier. Therefore, both telephony parties can hear the background sound while talking.

To achieve the above object, the present invention provides a method for providing a background sound effect for mobile phone communication through a carrier. An initial talking message such as a call-answering message by any of the two communication parties is first detected and a background sound effect is selected in an audio memory module in the mobile phone. The background sound effect is sent with the carrier by a DSP unit. Therefore, the two communication parties can simultaneously hear the background sound effect.

### BRIEF DESCRIPTION OF DRAWING

The various objects and advantages of the present invention will be more readily understood from the following detailed description when read in conjunction with the appended drawing, in which:

FIG. 1 shows a block diagram of a mobile phone according to the present invention; and

FIG. 2 shows the flowchart of the present invention.

### DETAILED DESCRIPTION OF THE INVENTION

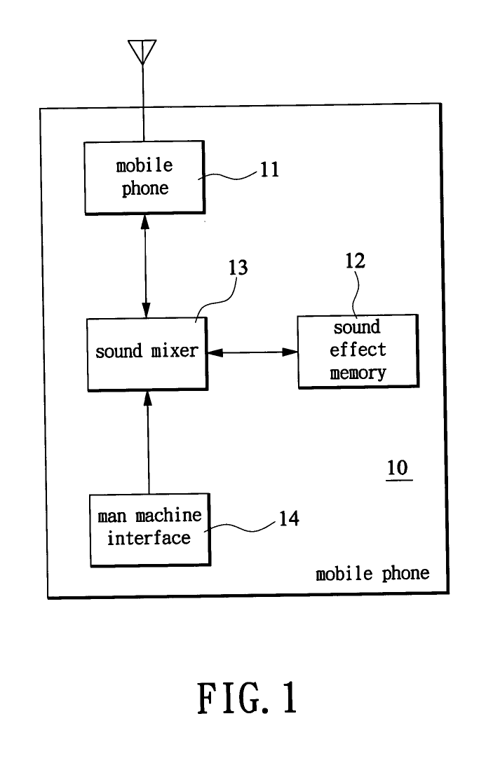

FIG. 1 shows a block diagram of a mobile phone 10 according to the present invention. The mobile phone 10 is equipped with a plurality of sets of background sounds such as sound mimicking surf, a train station, a metro station or a brook, or classical or soft music. The background sound can be set up or selected to provide the mobile phone 10 with personalized sound effect.

As shown in FIG. 1, the mobile phone 10 comprises at least one wireless transceiver 11, a sound effect memory 12, a sound mixer 13, and a man-machine interface 14. The wireless transceiver 11 is functioned to send/receive a wireless carrier for carrying the voice signal of the mobile phone 10. The wireless transceiver 11 can be used for GSM, GPRS or 3G systems, and the wireless carrier is for GSM, GPRS or 3G systems.

The sound effect memory 12 has a plurality sets of background sound effects stored therein and can be realized by a ROM, in which the background sound effect is permanently recorded, or by a flash memory, in which the background sound effect is recorded or downloaded thereto by the user.

The sound mixer 13 is a digital signal processor (DSP) and connected to the wireless transceiver 11 and the sound effect memory 12. The sound mixer 13 fetches at least one sound effect from the sound effect memory 12.

The man-machine interface 14 is used by the user for accessing the mobile phone. The man-machine interface 14 is connected to the sound effect memory 12, whereby a user can select a sound effect from the sound effect memory 12 and mix the same into carrier. The user also can use the man-machine interface 14 to record desired background sound effects in the sound effect memory 12, or download a background sound effect to the sound effect memory 12 through a communication network or the Internet.

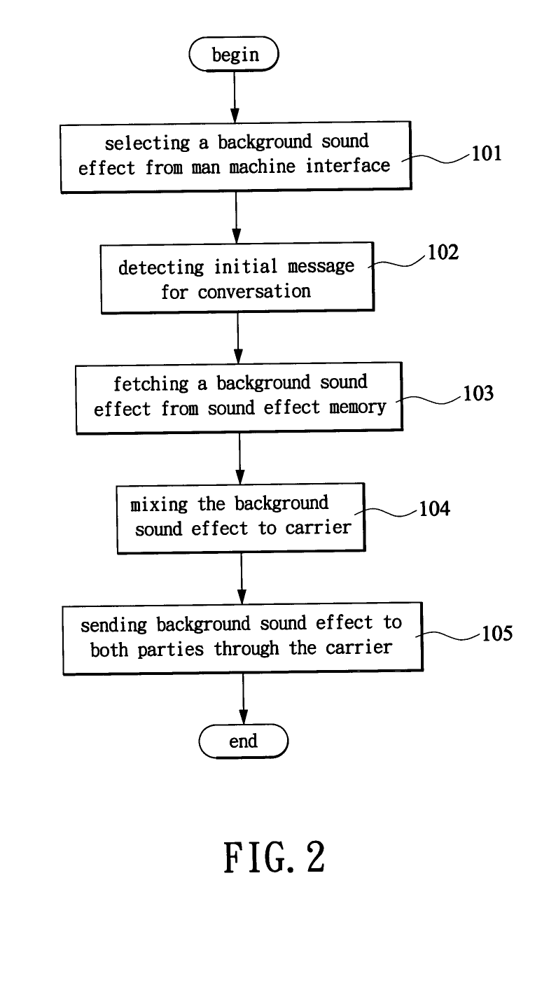

FIG. 2 shows the flowchart of the present invention, in which the background sound effect is mixed by the wireless carrier and heard by two conversation parties using the mobile phone according to the present invention. At first step 101, a user uses the man-machine interface 14 to select a background sound effect. Afterward, the mobile phone detects an initial message when the user uses the mobile phone for conversation at step 102. The initial message can be one of messages to indicate a dialing action, a reception message for called party and a reception message for the user.

Afterward, the file for the selected background sound effect is fetched from the sound effect memory 12 at step 103. The sound mixer 13 mixes the selected background sound effect to the carrier at step 104. Therefore, both conversation parties can hear the selected background sound effect carried by the carrier during conversation at step 105.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A method for providing a background sound effect for a mobile phone, the mobile phone using a carrier as a communication medium, the method comprising:
providing an initial message for conversation; and
providing a background sound effect carried by the carrier, whereby two parties communicating through the mobile phone can hear the background sound effect.

2. The method for providing a background sound effect for a mobile phone as in claim 1, wherein the initial message for conversation is an initial message indicating a called party receiving a phone call as being called by a calling party using the mobile phone.

3. The method for providing background sound effect for mobile phone as in claim 1, wherein the initial message for conversation is an initial message indicating a user of the mobile phone picking up a phone call.

4. The method for providing a background sound effect for a mobile phone as in claim 1, wherein the background sound effect is stored in a memory of the mobile phone.

5. The method for providing a background sound effect for a mobile phone as in claim 4, wherein the memory is a read-only memory and the background sound effect is pre-recorded in the memory.

6. The method for providing a background sound effect for a mobile phone as in claim 4, wherein the memory is a flash memory and the background sound effect is recorded in the memory or downloaded to the memory from a network.

7. The method for providing a background sound effect for a mobile phone as in claim 6, wherein the network is a communication network or an Internet.

8. The method for providing a background sound effect for a mobile phone as in claim 1, wherein the background sound effect is mixed in the carrier by a digital signal processor.

9. The method for providing a background sound effect for a mobile phone as in claim 1, wherein the carrier is a GSM carrier, a GPRS carrier or a 3G carrier.

10. A mobile phone providing a background sound effect, comprising
a wireless transceiver for sending and receiving a wireless carrier for the mobile phone, the wireless carrier carrying voice signals of two conversation parties;
a sound effect memory storing at least one background sound effect; and
a sound mixer connected to the wireless transceiver and the sound effect memory, the sound mixer fetching a background sound effect from the sound effect memory and mixing the background sound effect for the carrier, whereby the two conversation parties hear the background sound effect.

11. The mobile phone providing a background sound effect as in claim 10, wherein the wireless transceiver is a GSM transceiver, a GPRS transceiver or a 3G transceiver.

12. The mobile phone providing a background sound effect as in claim 10, wherein the carrier is a GSM carrier, a GPRS carrier or a 3G carrier.

13. The mobile phone providing a background sound effect as in claim 10, wherein the sound effect memory is a read-only memory and the background sound effect is pre-recorded in the memory.

14. The mobile phone providing a background sound effect as in claim 10, wherein the memory is a flash memory and the background sound effect is recorded in the memory or downloaded to the memory from a network.

15. The mobile phone providing a background sound effect as in claim 10, wherein the sound mixer is a digital signal processor.

16. The mobile phone providing a background sound effect as in claim 10, further comprising a man-machine interface connected to the sound mixer, a user using the man-machine interface to select a background sound effect and mix the background sound effect for the carrier.
